(19) United States
(12) Patent Application Publication
(10) Pub. No.: US 2012/0019862 A1
(43) Pub. Date: Jan. 26, 2012

(54) IMAGE PROCESSING APPARATUS, CONTROL METHOD OF IMAGE PROCESSING APPARATUS, AND PROGRAM

(75) Inventor: Junichi Hiruma, Hidaka-shi (JP)

(73) Assignee: CANON KABUSHIKI KAISHA, Tokyo (JP)

(21) Appl. No.: 13/187,278

(22) Filed: Jul. 20, 2011

(30) Foreign Application Priority Data
Jul. 22, 2010 (JP) 2010-165313

(51) Int. Cl. G06F 15/00

(52) U.S. Cl. 358/1.15

(57) ABSTRACT

An image processing apparatus capable of displaying an operation screen based on screen information received from an external apparatus includes a storage unit, data storage unit, a transmission unit, and a control unit. The storage unit stores internal screen information for displaying an operation screen. The data storage unit stores data set via an operation screen based on received screen information. The transmission unit transmits set data to the external apparatus. When the image processing apparatus cannot receive screen information in response to transmitted data from the external apparatus, the control unit performs control to display an operation screen with the internal screen information in which the stored data is reflected.

### BACKGROUND OF THE INVENTION

1. Field of the Invention

The present invention relates to an image processing apparatus capable of displaying an operation screen provided by an external apparatus connected via a network, and a control method of the image processing apparatus, and a program.

2. Description of the Related Art

Japanese Patent Application Laid-Open No. 2006-127503 discusses a system in which an image processing apparatus provided with a browser, such as a Multi Function Peripheral (MFP), can communicate with an external server implementing a web application therein via a network. In this system, the browser receives screen information described by a Hyper Text Markup Language (HTML) which is provided by the external server, and displays an operation screen for operating the MFP based on the received screen information. The browser accepts a user operation via a displayed operation screen and functions of the MFP (for example, a copy function) are available to the user. Accordingly, when an operation screen of the MFP is provided by the external server, the MFP does not need to hold an operation screen of the MFP for itself. Further, a user can easily customize the operation screen by the web application on the external server.

It is generally known that a conventional MFP not connecting to a network displays an operation screen based on contents held by the MFP itself and functions of the MFP become available by operating the operation screen.

A MFP, which can display both operation screens based on an operation screen provided by the external server and contents stored in the MFP itself, operates on one of operation screens and can use the same MFP function.

### SUMMARY OF THE INVENTION

The present invention provides an image processing apparatus which, when an error occurs while a user operates an operation screen provided by an external server, can continue the operation which has been performed by a user on an operation screen before occurrence of the error, without carrying out an operation again on an operation screen held by the MFP. The error that occurs is, for example, a network failure, or that the MFP cannot receive screen information from the external server.

One aspect of the present invention provides an image processing apparatus including an interface unit, a display unit, a storage unit, a data storage unit, a transmission unit, and a control unit. The interface unit is configured to receive screen information from an external apparatus via a network. The display unit is configured to display an operation screen based on screen information received by the interface unit. The storage unit is configured to store internal screen information for displaying an operation screen in the display unit. The data storage unit is configured to store data set via the operation screen displayed based on screen information received by the interface unit. The transmission unit is configured to transmit the set data to the external apparatus. The control unit is configured to, when screen information is received in response to the data transmitted by the transmission unit from the external apparatus, display an operation screen based on the received screen information. The control unit is further configured to, when screen information received in response to the data transmitted by the transmission unit cannot be received from the external apparatus, display an operation screen with the internal screen information stored in the storage unit, in which the data stored in the data storage unit is reflected.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is an entire view of an image processing apparatus according to a present exemplary embodiment.

FIG. 2 is a block diagram illustrating hardware configurations of a MFP and an external server.

FIG. 3 is a block diagram illustrating software configurations of the MFP and the external server.

FIGS. 4A, 4B, 4C, and 4D illustrate operation screens displayed in an operation unit.

FIG. 5 is a sequence view illustrating a series of processes in the MFP and the external server.

FIG. 6 is an example of a list of logs.

FIG. 7 is a view illustrating a table for determining whether a screen can be replaced by internal contents (internal screen information) when an error occurs.

FIG. 8 is a flowchart illustrating processing executed by the MFP.

### DESCRIPTION OF THE EMBODIMENTS

Various exemplary embodiments, features, and aspects of the invention will be described in detail below with reference to the drawings.

The following exemplary embodiment does not limit the invention of the claims. Further, all of the combinations of the features described in the present exemplary embodiment are not necessarily requisite for solving the problem dealt with in the present invention.

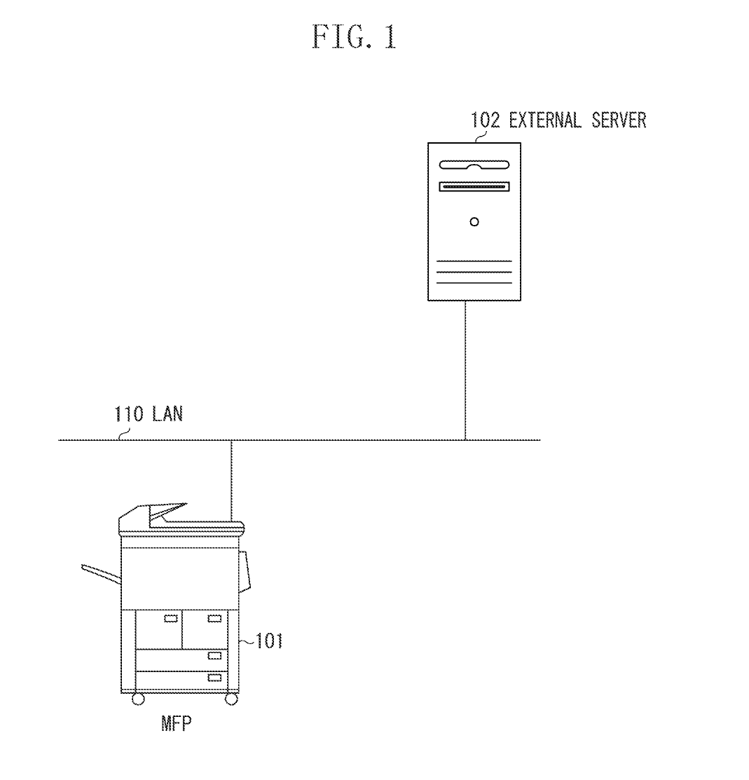

A configuration of an image processing system of the present exemplary embodiment will be described referring to FIG. 1. In the image processing system, a MFP 101 and an external server 102 are connected to each other via a local area network (LAN) 110.

The MFP 101 includes a plurality of functions, such as scanning, printing, copying, and electronic mail transmitting. The MFP 101 can be a single function peripheral (SFP) which includes one of the aforementioned functions. A plurality of MFPs 101 can be connected to LAN 110.

The MFP 101 further includes a browser 310. The browser 310 can receive screen information from the external server 102, analyze the received screen information, and display an operation screen in the operation unit 210 of the MFP 101. In the present exemplary embodiment, the screen information is provided in Hypertext Markup Language (HTML) format. The screen information can be provided in other formats, such as eXtensible Markup language (XML), Wireless Markup Language (WML), or Extensible Hypertext Markup Language (XHTML).

The external server 102 is an apparatus, such as a personal computer, a print server, a storage apparatus, etc. The external server 102 is provided with a web application and transmits contents of an operation screen required from the browser 310. In one embodiment, one external server 102 provides service. In another embodiment, the external server 102 can be include a plurality of servers and activate a plurality of virtual machines in the server groups to perform distributed processing. In the latter embodiment, a technique known as scale out (cloud computing), which increases the virtual machines depending on predetermined conditions, is used.

In the present exemplary embodiment, the MFP 101 and the external server 102 are connected via the LAN 110. However, any communication connection, such as a wide area network (WAN) or a Universal Serial Bus (USB) cable, etc. that would enable practice of the present invention is applicable.

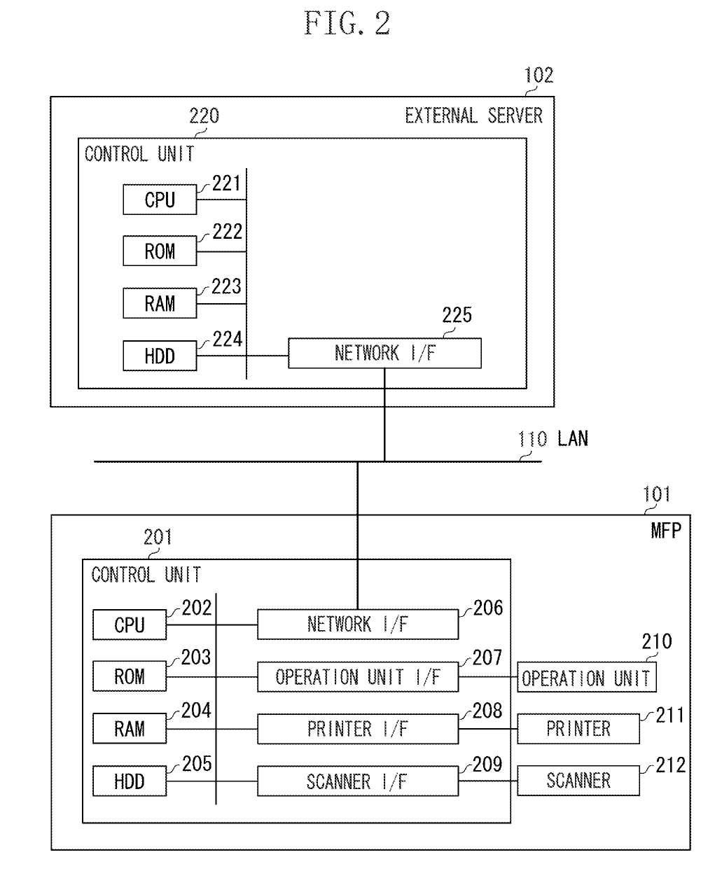

FIG. 2 illustrates hardware configurations of the MFP 101 and the external server 102. The hardware configuration of the MFP 101 will be described first. A control unit 201 containing a central processing unit (CPU) 202 controls an entire operation of the MFP 101. The CPU 202 reads a control program stored in a read only memory (ROM) 203 and performs various controls, such as a read control and a transmission control. A random access memory (RAM) 204 is used as a temporary storage area of a main memory and a work area of the CPU 202.

A hard disk drive (HDD) 205 stores image data and various control programs or various information tables. An operation unit interface (I/F) 207 is an interface connecting an operation unit 210 and the control unit 201. The operation unit 210 includes a liquid crystal display unit having a touch-panel function and a keyboard (not shown). While the present embodiment refers to a liquid crystal display unit with a touch-panel function and a keyboard, any interface design that would enable practice of the present invention is applicable. The browser 310 included in the MFP 101 displays, on the liquid crystal display unit in the operation unit 210, an operation screen generated based on screen information received from the external server 102.

A printer I/F 208 is an interface connecting a printer 211 and the control unit 201. Image data to be printed by the printer 211 is transferred from the control unit 201 via the printer I/F 209 and printed on a recording medium in the printer 211.

A scanner I/F 209 is an interface connecting a scanner 212 and the control unit 201. The scanner 212 reads an image on a document to form image data and inputs the data to the control unit 201 via the scanner I/F 209.

A network I/F 206 is an interface connecting the MFP 101 with the LAN 110. The network I/F 206 transmits various information such as image data to the external server 102 via the LAN 110 and receives various information such as image data from the external server 102 via the LAN 110.

The hardware configuration of the external server 102 will now be described. A control unit 220 containing CPU 221 controls the entire operation of the external server 102. The CPU 221 reads a control program stored in a ROM 222 and executes various control processing. A RAM 223 is used as a temporary storage area of the main memory of the CPU 221 and a work area. A HDD 224 stores image data and various programs or various information tables.

A network I/F 225 connects the the external server 102 to the LAN 110. The network I/F 225 transmits/receives various information to/from other apparatuses via the LAN 110.

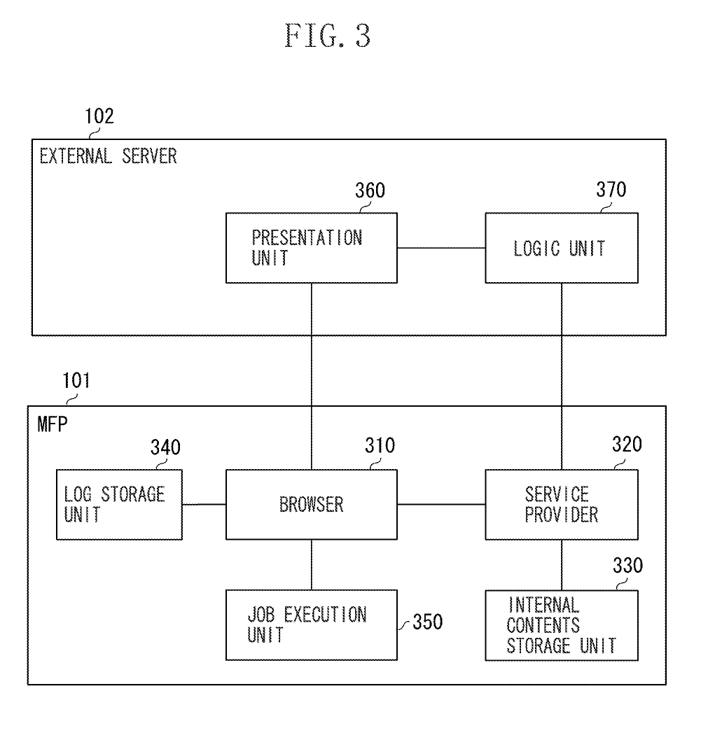

A software configuration of the image processing system illustrated in FIG. 1 will now be described with reference to FIG. 3.

The MFP 101 includes the browser 310, a service provider 320, a job execution unit 350, a log storage unit 340, and an internal contents storage unit 330. These units are software modules executed by CPU 202 and stored in the ROM 203.

The external server 102 is provided with a presentation unit 360 and a logic unit 370. These units are software modules executed by the CPU 221 and stored in the ROM 222.

The software configuration of the MFP 101 will be described first.

The browser 310 communicates with the presentation unit 360 in the external server 102 using the network I/F 206 according to a Hyper Text Transfer Protocol (HTTP). More specifically, the browser 310 first issues a request to a resource specified by Uniform Resource Locator (URL) (herein after referred to as a HTTP request). Then, the browser 310 receives screen information of an operation screen provided by the external server 102 in response to the HTTP request (hereinafter referred to as a HTTP response), generates an operation screen, and performs control to display the generated operation screen in the operation unit 210. In addition, if software can communicate with a web application on the external server 102 and acquire screen information from the external server 102 to display the screen in the operation unit 210, other software can be used instead of the browser 310. While the present embodiment is implemented using HTTP, any other protocol that would enable practice of the present invention is applicable.

The service provider 320 provides a web service requested from the external server 102. The web service is a service provided by software identified by Uniform Resource Identifier (URI). In the present exemplary embodiment, the service provider 320 receives a request according to Simple Object Access Protocol (SOAP) (hereinafter referred to as a SOAP request) from the external server 102. By executing the service provider 320 according to the SOAP request, the browser 310 executes a job using the job execution unit 330. The SOAP request is described by a XML format. For example, when the MFP 101 requests a copy web service, the SOAP request contains setting parameters necessary for copying, such as reading resolution, sheet size, magnification, number of copies, etc.. In the SOAP request, for example, a message requesting a copy job as a web service, is described. Examples of other jobs include, but are not limited to, “a scan job”, “a print job”, “a transmission job”, etc..

The job execution unit 350 executes a job created by the service provider 320. For example, when the job is a copy job, the job execution unit 350 uses the scanner 212 to read a paper document and temporally stores the associated image data in the RAM 204. Then, the job execution unit 350 uses the printer 211 to print the image data.

A log storage unit 340 stores a log in the RAM 204 each time the browser 310 issues a HTTP request to the external server 102. The log stores the HTTP request message, date and time of the HTTP request, and parameters set via the operation screen. The aforementioned data is just several examples of the data that the log storage unit 240 can store and the type of data to be stored is not limited to these examples.

An internal contents storage unit 330 stores internal contents of an operation screen displayed by the browser 310, such as internal screen information, in the HDD 205 and manages it. The internal contents are, for example, an HTML file and a Common Gateway Interface (CGI) script. An operation screen generated based on the internal contents (hereinafter referred to as a second operation screen) is a screen utilized as an alternative of an operation screen provided by the external server 102 (hereinafter referred to as a first operation screen), when a network communication failure occurs or when the MFP 101 cannot receive screen information within a predetermined time. When the MFP 101 is used as a standalone type apparatus which is not connected to the network, the MFP 101 does not utilize the internal contents as the alternative of the first operation screen, but rather as the only screen. Further, the MFP 101 displays the internal contents by means other than the browser 310. Thus, he MFP 101 displays the first operation screen via the browser 310 and the second operation screen via the means other than the browser 310.

The software configuration of the external server 102 will now be described with reference to FIG. 3.

A presentation unit 360 communicates with the browser 310 via the network I/F 225. The presentation unit 360 transmits screen information for displaying an operation screen in the operation unit 210 by the browser 360 to the MFP 101. The screen information is contained in an HTTP response. Further, the presentation unit 360 receives setting parameters input via the operation screen displayed on the operation unit 210 by the browser 310 as an HTTP request from the MFP 101. The presentation unit 360 then transmits screen information to the browser 310 as the HTTP response to the HTTP request. Furthermore, the presentation unit 360 provides the parameters input via the operation screen displayed by the browser 310 to a logic unit 370. In one embodiment, the presentation unit 360 and the logic unit 370 are located in the same external server 102. In another embodiment, they can be located remote from one another, e.g., in different apparatuses, wherein the apparatuses communicate with each other.

The logic unit 370, after acquiring the setting parameters the presentation unit 360, generates a SOAP request based on the setting parameters. The SOAP request is a request for a web service to the service provider 320 in the MFP 101. Then, the logic unit 370 transmits the generated SOAP request to the service provider 320.

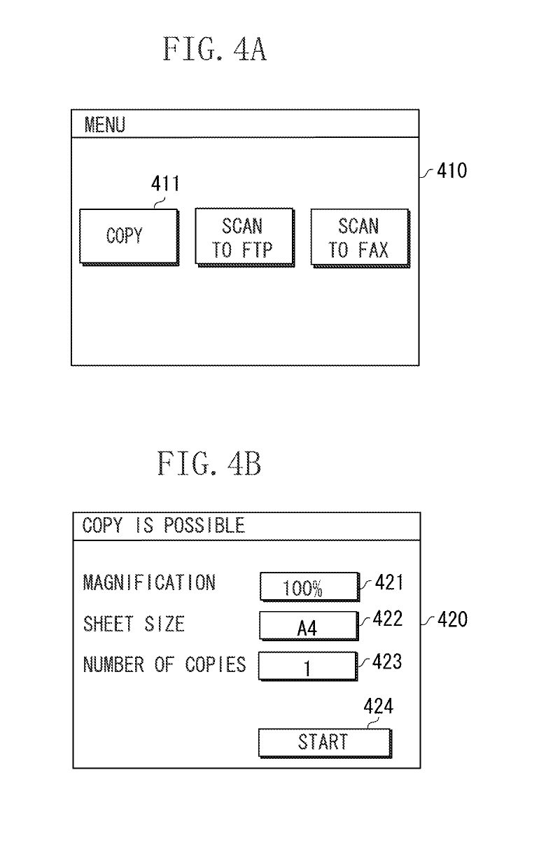

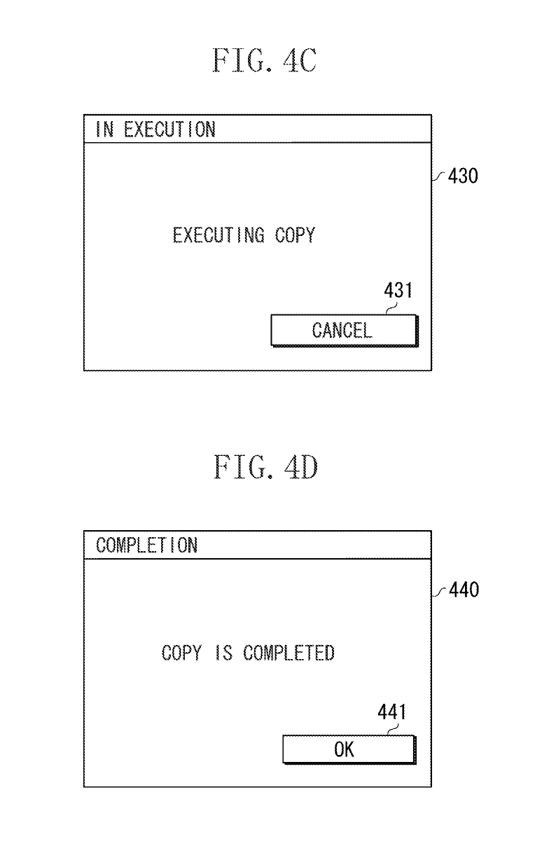

FIGS. 4A-4D illustrate examples of operation screens displayed in the operation unit 210 by the browser 310. When the browser 310 starts, the operation unit 210 displays a menu screen 410 as an initial screen as illustrated in FIG. 4A. Copy button 411 is displayed in the menu screen 410. When a user presses the copy button 411, the screen shifts to copy screen 420 as illustrated in FIG. 4B.

In the copy screen 420, a magnification setting button 421, a sheet size setting button 422, a number of copies setting button 423, and a start button 424 are displayed. When the user presses either the magnification setting button 421, the sheet size setting button 422, or the number of copies setting button 423, a list of the parameters associated with the particular selected button is displayed. The user can set specified parameters from the displayed list. In addition, the user can input desired values to these items via the operation unit 210. After setting the parameters of the magnification, the sheet size, and the number of copies, the user presses start key 424 to initiate copying, and the screen shifts to an execution screen 430 as illustrated in FIG. 4C. A message indicating that copying is being executed is displayed in the execution screen 430. When copying is completed, the screen automatically shifts to a completion screen 440 as illustrated in FIG. 4D. If the user presses cancel button 431 during the copying process, the screen shifts to the copy screen 420 in FIG. 4B and the copy job is interrupted. In the completion screen 440 illustrated in FIG. 4D, a message indicating that copying has completed is displayed. When the user presses OK button 441, the screen shifts to the menu screen 410.

In the present exemplary embodiment, the operation screens in FIG. 4A to FIG. 4D are displayed by the browser 310 based on screen information provided by the presentation unit 360 in the external server 102 or internal contents stored in the internal contents storage unit 330. When the browser 310 detects that a button in an operation screen is pressed, the browser 310 acquires screen information associated with the next operation screen that will be displayed as a result of pressing the button from the external server 102 using a URL assigned to each button as an access destination.

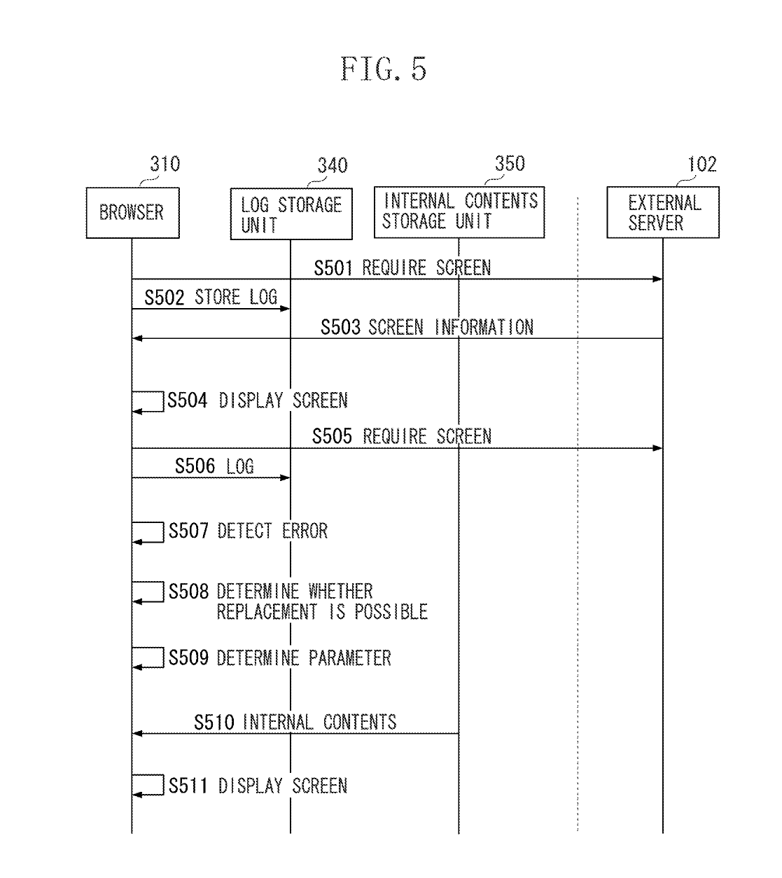

FIG. 5 is a sequence view illustrating an example of processing occurring between the MFP 101 and the external server 102. More particularly, it illustrates an example of the screen of MFP 101 being replaced by an operation screen based on the internal contents instead of an operation screen provided by the external server 102 due to a communication error between the MFP 101 and the external server 102.

First, in step S501, when browser 310 is launched, the browser 310 transmits an HTTP request to the presentation unit 360. The browser 310 specifies a URL indicating a storage place of the operation screen and transmits the HTTP request using a GET method.

In step S502, the browser 310 stores a log in the log storage unit 340.

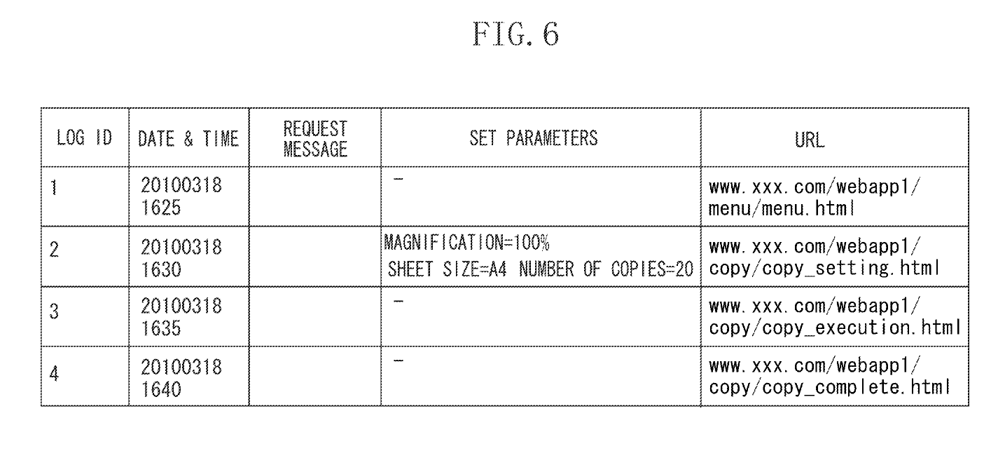

FIG. 6 illustrates an exemplary embodiment of a list of logs stored in the log storage unit 340. The log storage unit 340 stores date and time, a request message, setting parameters, and a URL and associates this data with a particular log ID. The date and time is a transmission date and time of an HTTP request. The request message is a message transmitted to the presentation unit 360. The setting parameters are parameters received an operation performed via a particular operation screen. The URL is a URL specified by a message of the HTTP request. A record having log ID “1” indicates that the message of the HTTP request was transmitted to the external server 102 at 16:25 on Mar. 18, 2010, specifying the URL as www.xxx.com/webapp1/menu/menu.html. This URL indicates a place where the screen information of the menu screen 410 in FIG. 4A is stored. The “−” in the setting parameters indicates no parameters have been set via the menu screen 410.

The record having log ID “2” indicates that the message of the HTTP request was transmitted to the external server 102 at an access time of 16:25 on Mar. 18, 2010, specifying the URL as www.xxx.com/webappl/copy/copy_setting.html. This URL indicates a place where the screen information of the copy screen 420 in FIG. 4B is stored. The setting parameters, i.e., magnification=100, sheet size=A4, number of copies=20″ are the parameters input via the copy screen 410.

The log having the log ID “3” indicates that the HTTP request was transmitted at 16:35 on Mar. 18, 2010, specifying the URL as www.xxx.com/webappl/copy/copy_execution.html, which is where the execution screen 430 in FIG. 4C is stored.

The log having the log ID “4” indicates that the HTTP request was transmitted at 16:40 on Mar. 18, 2010, specifying URL as www.xxx.com/webappl/copy/copy_complete.html, which is where the completion screen 441 in FIG. 4D is stored. As described above, in the present exemplary embodiment, the browser 310 updates the log each time an HTTP request is transmitted.

Retuning to FIG. 5, in step S503, the browser 310 receives an HTTP response from the external server 102 in response to the HTTP request sent in step S501. In step S504, the browser 310 analyzes the screen information contained in the HTTP response, generates an associated operation screen, and displays it in the operation unit 210.

In step S505, similar to step S501, the browser 310 requests a screen to the external server 102. In step 5506, similar to step S502, the browser 310 stores a log in the log storage unit 340.

In the present exemplary embodiment, it is presumed that a communication error occurs while the browser 310 communicates with the presentation application 360 on the external server 102. The communication error can be, for example, that (1) there is no response within a predetermined time after transmitting an HTTP request, (the browser 310 cannot receive an HTTP response), (2) the browser 310 cannot transmit an HTTP request to the external server 102 due to network issues, or (3) the browser 310 receives a message in which the external server 102 cannot transmit an HTTP response since the external server 102 is performing other processing.

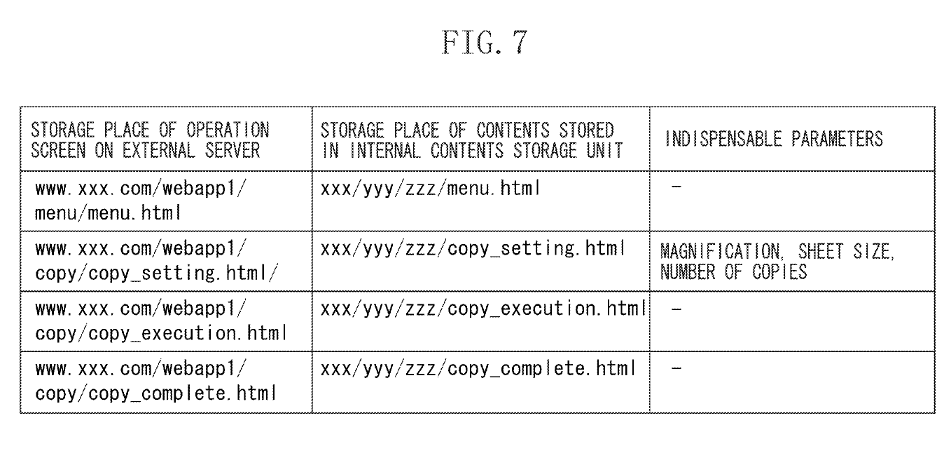

In step S507, the browser 310 detects the occurrence of a communication error. When the browser 310 detects a communication error, in step S508, the browser 310 determines whether the first operation screen displayed immediately before the error can be replaced by the second operation screen. More specifically, the browser 310 refers to the logs in FIG. 6 and acquires the URL in the log associated with the latest access time. Then, the browser 310 refers to the exemplary table illustrated in FIG. 7. This table stores screen information in the first operation screen in association with the storage place of the internal contents, which is the screen information of the second operation screen. Indispensable parameters are the parameters which are needed when the browser 310 replaces the operation screen with the internal contents. The information illustrated in FIG. 7 is stored in the HDD 205 and managed by the browser 310.

When the URL of the log at the latest time is “www.xxx.com/webappl/copy/copy_setting.html”, the browser 310 determines the URL of the internal contents (“xxx/yyy/zzz/copy/copy_setting.html”) corresponding to this URL, and then determines that replacement by the internal contents is possible. When the browser 310 determines that replacement is possible, the flow of FIG. 5 proceeds to step 509.

On the other hand, when the URL of the latest log is a URL which is not stored in the table (for example, “www.xxx.com/webapp2/scantoftp.html”), no internal contents corresponding to this URL exists, thus, the browser 310 determines that replacement is impossible.

Turning back to FIG. 5, in step S509, the browser 310 acquires, from the table in FIG. 7, indispensable parameters of the internal contents determined to be replaceable, and checks whether the indispensable parameters are stored in the log storage unit 340 as a log. When the indispensable parameters in FIG. 7 are stored in the log storage unit 340, in step S510, the browser 310 acquires the internal contents from the internal contents storage unit 330. Then, in step S511, the browser 310 displays an operation screen in which the setting parameters stored in the log storage unit 350 are automatically set to the acquired internal contents.

For example, the URL of the internal contents, which is determined to be replaceable, is an operation screen specified by “www.xxx.com/webappl/copy/copy_setting.html”, indispensable parameters in this operation screen are parameters of a sheet size, magnification, and number of copies. The browser 310 checks whether these parameters are stored as setting parameters of the log at a latest time. In the log storage unit 340, the magnification, the sheet size, and the number of copies are set as the setting parameters, in association with “www.xxx.com/webapp1/copy/copy setting.html”, so that the browser 310 determines that the indispensable parameters are stored in the log.

On the other hand, a URL of the internal contents, which is determined to be replaceable, is an operation screen specified by “www.xxx.com/webapp1/menu/menu.html”, there is not indispensable parameters, and the browser automatically determines that the indispensable parameters are stored in the log.

Usually, when the first operation screen and the second operation screen have the same layout, setting parameters stored as a log and indispensable parameters in the internal contents are identical. In such a case, the browser 310 reflects all of setting parameters stored as a log to the internal contents and displays an operation screen. However, when screen information is customized by a web application in the external server 101, the first operation screen and the second operation screen may not be identical. In such a case, the browser 310 displays an operation screen without reflecting the unidentical parameters to the internal contents.

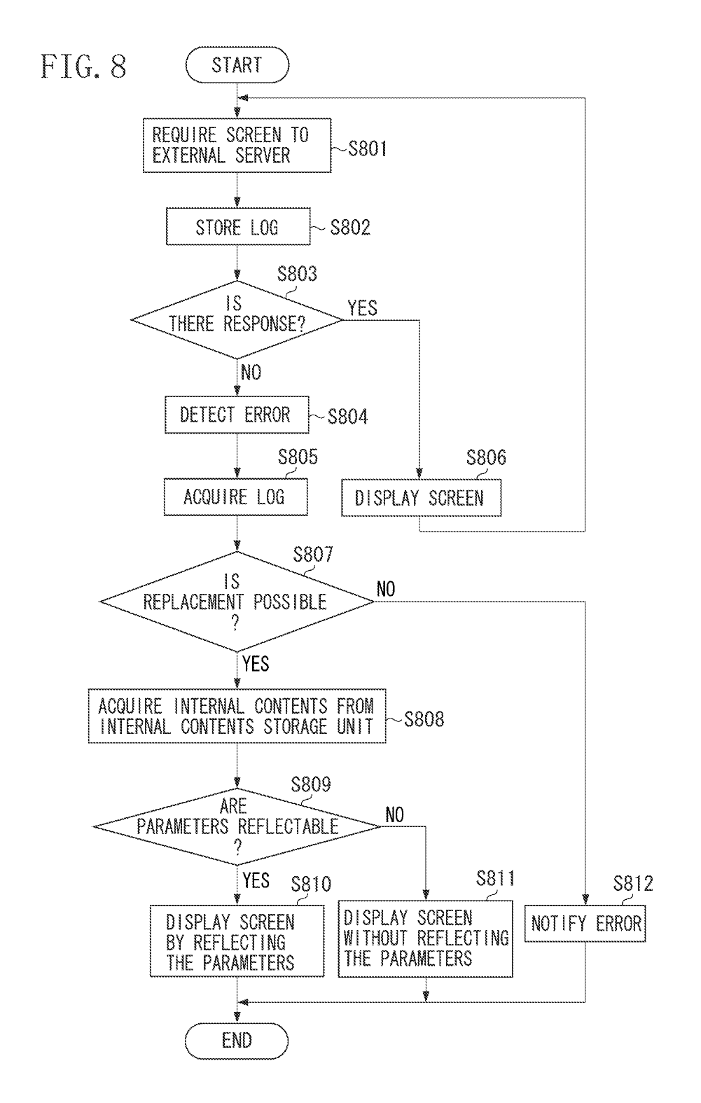

FIG. 8 illustrates an exemplary flowchart of processing executed by the MFP 101. The CPU 202 executes programs stored in the ROM 203 or the HDD 205 and realizes the steps of the illustrated flowchart. The present flowchart starts when an instruction to start the browser 310 is received via the operation unit 210.

In step S801, the browser 310 requires an operation screen to the external server 102. In step S802, the browser 310 stores the log of FIG. 6 in the log storage unit 340. In step S803, the browser 310 determines whether screen information is received within a predetermined time as a response from the external server 102.

When the browser 310 determines that the screen information is received, the processing proceeds to step S806 and the browser 310 displays the first operation screen. When the browser 310 determines that the screen information is not received within the predetermined time, in step S804, the browser 310 detects an error. This error detection corresponds to the processing described above with respect to step S507 in FIG. 5. In step S805, the browser 310 acquires the log.

In step S807, the browser 310 refers to the log acquired from the log storage unit 340 in step S805 and the table illustrated in FIG. 7, and determines whether replacement of the first operation screen with the second operation screen is possible. This determination corresponds to the processing described above with respect to step S508 in FIG. 5.

When the browser 310 determines in step S807 that the replacement is possible, in step S808, the browser 310 acquires, from the internal contents storage unit 330, the internal contents of the second operation screen which is determined as replaceable. When the browser 310 determines that replacement is impossible, the processing proceeds to step S812, the browser 310 notifies that an error condition has occurred, and processing ends.

In step 809, the browser 310 checks whether the parameters are identical with the indispensable parameters in the internal contents stored as setting parameters of the log at a latest time. This determination corresponds to the processing described above with respect to step S509 of FIG. 5. When the browser 310 determines that the parameters are stored, the processing proceeds to step S810, and the browser 310 displays an operation screen with the setting parameters being set, based on the internal contents acquired in step S808. After displaying the operation screen in step S810, the browser 310 performs the screen transition on the operation screen (the second operation screen) based on the internal contents. According to this operation, even when the browser 310 cannot communicate with the external server 102 while operating, the browser 310 can continue with the rest of the initiated operation.

When the browser 310 instructs an execution of a job via the operation screen based on the internal contents, the job execution unit 350 executes the job based on the instruction. According to this operation, even when the browser 310 cannot communicate with the external server 102 while operating, the browser 310 can continue the operation until the job execution is completed.

When the browser 310 determines that the indispensable parameters are not stored as the log at the latest time, the processing proceeds to step S811, and the browser 310 displays the second operation screen on the operation unit 210 without setting the parameters to the items on the operation screen. In this case, the user inputs parameters anew via the second operation screen.

According to the present exemplary embodiment, when an error, such as a communication obstacle, occurs while a user is operating an operation screen provided by the external server 102, the user can continue the processing on the operation screen based on internal contents (internal screen information), reflecting setting contents operated by the user before occurrence of the error.

In the present exemplary embodiment, the storage of a log (step S502, step S506, and step S802) by the log storage unit 340 is performed in response to the requirement of the screen information made to the external server 102 by the browser 310. The log storage unit stores the log in the HDD 205. However, this processing can be modified and performed as follows. The browser 310 confirms that the required screen information can be normally received from the external server 102 and the operation screen based on the received screen information can be displayed. Then the browser 310 provides an instruction to store the log in the log storage unit 340. If the browser 310 gives the instruction to store the log in the log storage unit 340 in response to the normal receiving of the screen information, the log cannot be stored in the log storage unit 340 when the browser 310 is unable receive the screen information from the external server 102. Therefore, if the browser 310 detects an error, the browser 310 can display the internal contents corresponding to the latest screen information that was received.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-165313 filed Jul. 22, 2010, which is hereby incorporated by reference herein in its entirety.

What is claimed is:

1. An image processing apparatus comprising:
an interface unit configured to receive screen information from an external apparatus via a network;
a display unit configured to display an operation screen based on screen information received by the interface unit;
a storage unit configured to store internal screen information for displaying an operation screen in the display unit;
a data storage unit configured to store data set via the operation screen displayed based on screen information received by the interface unit;
a transmission unit configured to transmit the set data to the external apparatus; and
a control unit configured to, when screen information is received in response to the data transmitted by the transmission unit is received from the external apparatus, display an operation screen based on the received screen information and, when screen information received in response to the transmitted data cannot be received from the external apparatus, to display an operation screen with the internal screen information stored in the storage unit, in which the data stored in the data storage unit is reflected.

2. The image processing apparatus according to claim 1,
wherein the control unit determines that the screen information received in response to the transmitted data cannot be received when screen information is not received within a predetermined time after the set data is transmitted.

3. The image processing apparatus according to claim 1,
wherein, when the screen information received in response to the transmitted data cannot be received, the control unit is configured to display an operation screen based on internal screen information stored in association with the screen information received by the interface unit.

4. The image processing apparatus according to claim 1 further comprising:
an image processing unit configured to perform image processing according to an operation via the operation screen,
wherein the set data is parameters used by the image processing unit.

5. The image processing apparatus according to claim 1,
wherein the control unit determines, based on the internal screen information, whether data stored by the data storage unit is identical to data set on the operation screen, displays the data determined to be identical, and displays unidentical data, which is not reflected on an operation screen based on the internal screen information.

6. The image processing apparatus according to claim 1,
wherein the control unit is a web browser.

7. The image processing apparatus according to claim 1,
wherein screen information received by the interface unit is described using a markup language.

8. The image processing apparatus according to claim 1,
wherein the internal screen information is described using a markup language.

9. The image processing apparatus according to claim 1,
wherein an operation screen based on screen information received by the interface unit and an operation screen based on internal screen information stored in the storage unit are identical.

10. The image processing apparatus according to claim 9,
wherein data set via an operation screen based on screen information received by the interface unit and data reflected on an operation screen based on the internal screen information are the identical data.

11. A method for controlling an image processing apparatus, the method comprising:
receiving screen information from an external apparatus;
displaying an operation screen based on the received screen information;
storing internal screen information for displaying an operation screen;
storing data set via the operation screen based on the received screen information;
transmitting the set data to the external apparatus;
determining whether screen information received in response to the transmitted data is received from the external apparatus;
displaying an operation screen based on the received screen information when it is determined that screen information is received, and displaying an operation screen with the internal screen information, in which the stored data is reflected when it is determined that screen information is not received.

12. A computer-readable storage medium configured to store a computer-readable program which causes an image processing apparatus to execute the method according to claim 11.
